(19) United States
(12) Patent Application Publication
(10) Pub. No.: US 2004/0203741 A1
(43) Pub. Date: Oct. 14, 2004

(54) Communication systems having a function that allows communication between mobile and non-mobile facsimile terminals using different communication protocols

(76) Inventors: Yasuro Hori, Katsuta-shi (JP); Kouzou Nakamura, Hitachioota-shi (JP); Soshiro Kuzunuki, Katsuta-shi (JP); Toshiaki Nakamura, Hitachi-shi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/406,499

(22) Filed: Apr. 4, 2003

Related U.S. Application Data
(63) Continuation of application No. 08/842,406, filed on Apr. 24, 1997, now abandoned.
Application No. 08/842,406 is a continuation of application No. 08/590,732, filed on Jan. 24, 1996, now abandoned.
Application No. 08/590,732 is a continuation of application No. 08/408,161, filed on Mar. 21, 1995, now abandoned.
Application No. 08/408,161 is a continuation of application No. 08/139,905, filed on Oct. 22, 1993, now abandoned.

(30) Foreign Application Priority Data
Oct. 22, 1992 (JP) 4-284165
Dec. 2, 1992 (JP) 4-322891

(51) Int. Cl. H04Q 7/20

(52) U.S. Cl. 455/426.1; 455/422.1

(57) ABSTRACT

A communication system, usable as a radio facsimile system, can transmit/receive information using a dedicated protocol independently of the radio wave status, as well as improve the transmission efficiency by restarting the subject communication even when it is interrupted and restarting the communication beginning with the data immediately following the normally transmitted data. A communication controller relays the communications between radio facsimile and general facsimile, and changes protocols appropriate to the subject communication to reduce interruptions. In addition, when the subject communication is interrupted, the communication system can cope with it to continue the communication by re-dialing automatically at fixed intervals, adding the communication discrimination information for each communication, and sending communication discrimination information and position information concerning the data received immediately prior to the interruption.

The present application is a continuation of application Ser. No. 08/842,406, filed Apr. 24, 1997; which is a continuation of application Ser. No. 08/590,732, filed Jan. 24, 1996; which is a continuation of application Ser. No. 08/408,161, filed Mar. 21, 1995, now abandoned; which is a continuation of application Ser. No. 08/139,905, filed Oct. 22, 1993, now abandoned, the contents of which are incorporated herein by reference.

### BACKGROUND OF THE INVENTION

The present invention relates to a communication terminal, such as a business or a home use facsimile or a communication system comprising those terminals, and in particular to a radio communication system.

In general, facsimile communications are performed through a wire-link public telephone line. However, a facsimile having radio communication functions has been introduced in Japanese Patent Laid-Open No. 51754/1989 and No. 90664/1992. The communication between a facsimile and one installed on a moving train or automobile is sometimes interrupted due to the occurrence of phasing or interference between radio waves. For a portable telephone communicating with a facsimile installed on a moving vehicle, the communication seems to continue, but actually it is often discontinued.

As for communications by voice, an interrupted communication can be compensated by voice data received before and after the voice data that has been lost. Also, when you cannot understand what the talker is talking about, you can ask the talker to repeat it again and again. So, almost no problem will arise from such voice communications.

In the case of the communication system introduced in Japanese Patent Laid-Open No. 101368/1991, when a communication is interrupted, the receiver saves the interrupted information. Then the receiver notifies the transmitter of the point at which the communication was interrupted and restarts the communication at the interruption point.

The facsimile communication protocol (group 3 protocol) does not allow communications to be interrupted. If interrupted, it is regarded as a communication disabled error. Actually, to cope with such an error in the case of communication involving an automobile, the subject automobile stops at a place with better conditions of radio wave transmission. In order to enable communications from/to a moving object, a communication system is introduced on pages 152 and 51 through 54 of “Dedicated DSP Applied Mobile Body Terminal” issued by Oki Denki Kaihatsu in October, 1991; the system comprises a facsimile in which a cellular modem is built in along with a protocol changer. Data is sent from a cellular telephone exchange through a public telephone line to individual facsimiles equipped with a protocol changer.

The prior art cannot solve the following problems, however. 1) The facsimile communication is disabled during movement of the transmitter or receiver due to radio wave interferences caused by radio wave interference phasing, etc. if the conventional G3 protocol is used for the communication.

2) The communication is enabled with a dedicated protocol that is tolerant of radio wave interruptions or with its own protocol. However, no communication with general facsimiles is possible. Thus, the communication range is limited.

3) In the case of a communication system in which the receiver notifies the transmitter of the interruption point when the communication is interrupted, the system has no function to discriminate the subject communication from others, if there are two or more communications being carried out. If there are two or more interrupted communication items, therefore, the target interruption point cannot be known. In order to cope with this problem, the communication must be restarted without fail just after it is interrupted.

4) In this case, the receiver must notify the transmitter of this situation and bear the expense. In addition, the transmitter must be equipped with a large memory to restore the lost information according to the interruption point or it must be equipped with complicated scanning functions to re-read the transmit data starting at the interruption point in order to judge the interruption point.

### SUMMARY OF THE INVENTION

The purpose of this invention is to provide a communication terminal and a communication system that can solve the above-mentioned problems and can communicate with general communication terminals connected to public telephone lines when moving from one location to another.

In order to achieve this purpose, this invention allows its original communication protocol that is tolerant of radio wave interruptions to be installed in two or more mobile communication terminals and the communication controller in the base station for communications. This invention also allows the communication terminals to have a function to change protocols between the said original communication protocol and general communication protocols, as well as a function to transfer information to general communication terminals connected to public telephone lines. In addition, the communication terminal and the communication system mentioned in this invention also have a means to exchange the subject communication peculiar discrimination information with the base station respectively when the communication is restarted after an interruption, as well as a means to exchange information indicating the interruption point to eliminate the load of the public telephone line or the receiver of the mobile unit.

In the case of communication between at communication terminal connected to a public telephone line and a moving communication terminal, information is transmitted first from the communication terminal connected telephone line to a communication controller in a base station using a general protocol. The general protocol is changed to the original one in the communication controller. After this, information is transmitted from the base station to the moving communication terminal in the form of radio waves. On the other hand, when the moving communication terminal transmits data to the controller in the base station using its original protocol, the communication controller in the base station changes the protocol to a general one and transfers data to the specified general communication terminal through the public telephone line. If the communication with a moving communication terminal is disconnected and then quickly re-connected, the transmitter transmits communication discrimination information to the receiver to restart the communication and requests the receiver to transmit interruption point information. The receiver then transmits the requested information to the transmitter, which then restarts the transmission at the interruption point. Thus, even when two or more communications are interrupted, the communications can be restarted as required. And, since the transmitter notifies the receiver when the communication is to be restarted, the receiver is free from the burden of this processing.

### BRIEF DESCRIPTION OF DRAWINGS

FIG. 1 shows the system configuration in an embodiments of this invention.

FIG. 2 shows the configuration of a radio facsimile terminal for use in an embodiment of this invention.

FIG. 3 shows the configuration of a communication controller for use in an embodiment of this invention.

FIG. 4 explains a general communication protocol.

FIG. 5 explains the dedicated communication protocol used in this invention.

FIG. 6 shows the communication block length.

FIG. 7 shows another embodiment of this invention.

FIG. 8 shows the configuration of another facsimile terminal for use in this invention.

FIG. 9 shows the connection between a radio facsimile terminal and a portable telephone.

FIG. 10 shows another configuration of a communication controller for use in this invention.

FIG. 11 shows an embodiment of a facsimile terminal for use in this invention.

FIG. 12 shows an embodiment of a transmission control table for use in this invention.

FIG. 13 shows an embodiment of a receiving control table for use in this invention.

FIG. 14 explains a communication example 1.

FIG. 15 explains a communication example 2.

FIG. 16 explains an example of transmission.

FIG. 17 explains an example of receiving.

FIG. 18 explains an example of first calling.

FIG. 19 explains an example of re-calling.

FIG. 20 explains an example of receiving a first call FIG. 21 explains an example of receiving re-calls.

FIG. 22 explains an embodiment of this invention.

FIG. 23 explains communication characteristics.

### DESCRIPTION OF THE PREFERRED EMBODIMENTS

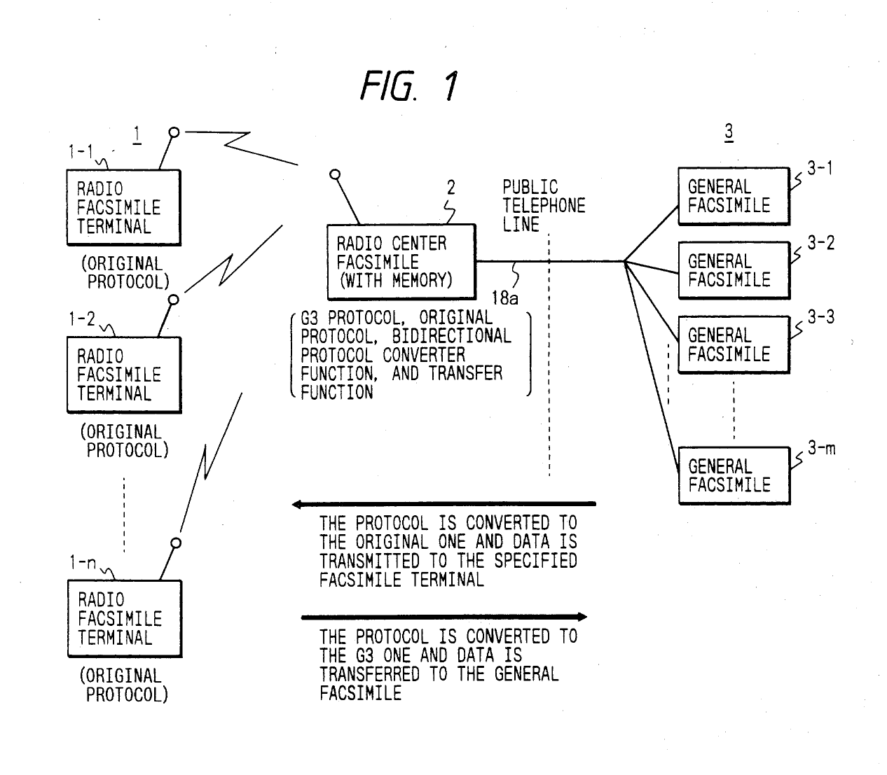

FIG. 1 shows the system configuration of this invention. The system comprises a mobile or a portable radio facsimile terminal group 1 having radio facsimile terminals 1-1 through 1-n operating on an original communication protocol, a radio center facsimile 2 equipped with a function to change protocols between general protocols and the said original protocol and a function to transfer data to general facsimile terminals, and a facsimile terminal group 3 having general facsimile terminals 3-1 through 3-m connected to a public telephone line.

In this system configuration, the signals from a general facsimile terminal of group 3 are transmitted to the radio center facsimile 2 through a public telephone line 18a. The general protocol is changed to the original protocol that is tolerant of radio wave interruptions, and then the signals are transmitted to a radio facsimile terminal of group 1 as radio waves, completing the communication. The radio facsimile terminal also has the original protocol.

On the other hand, the signals from a radio facsimile terminal 1 of group are transmitted to the radio center facsimile 2 as radio waves using the said original protocol. The radio center facsimile 2 changes the original protocol to a general protocol, and then transfers the signals to a specified general facsimile terminal of group 3 through the public telephone line and completes the communication.

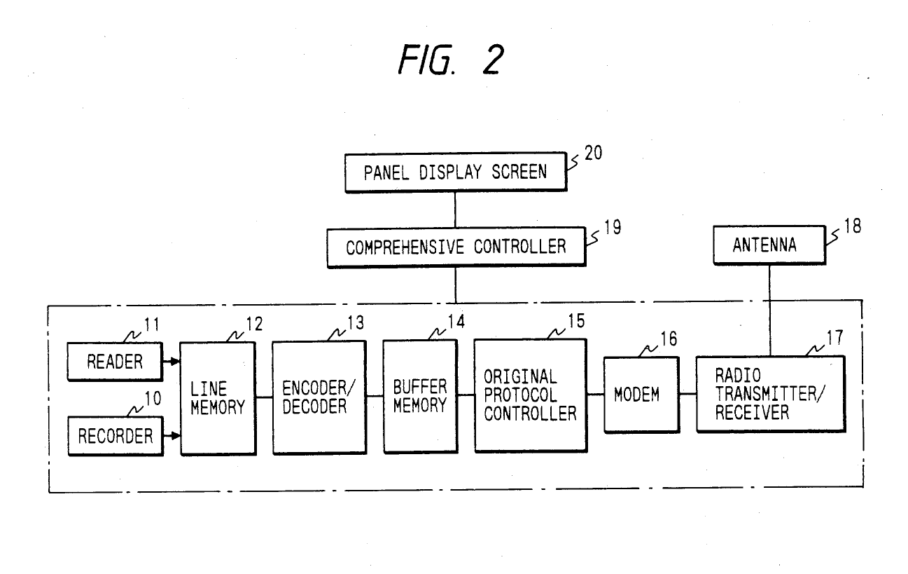

FIG. 2 shows the internal configuration of a radio facsimile terminal 1 as used in the group. Unlike ordinary facsimile terminals, this facsimile terminal comprises an original protocol controller 15, a radio transmitter/receiver 17, and an antenna 18. In the case of a radio telephone installed in an automobile, the antenna 18 and the radio transmitter/receiver 17 can be eliminated from the configuration, since telephone has those functions. The data read in the reader 11 is passed to the line memory 12, then encoded in the encoder/decoder 13, and then transmitted to the buffer memory 14. The protocol of the data from the buffer memory is changed to the radio protocol in the original protocol controller 15, and then the data is converted to analog signals through the modem 16 and converted to radio waves in the radio transmitter/receiver 17. The radio waves are then transmitted to the radio center facsimile terminal 2 from the antenna 18. The radio waves from the radio center facsimile 2 are caught by the antenna 18 of the radio facsimile terminal, and then converted to analog signals in the radio transmitter/receiver 17. The analog signals are then passed through the original protocol controller 15 and the buffer memory 14, restored to the original data in the encoder/decoder 13, passed through the line memory 12, and recorded in the recorder 10. The comprehensive controller 19 controls the information flow in each of the units, as well as the receiver information and the subject transmit information or the transmitter information and the received information to be displayed on the panel display screen 20.

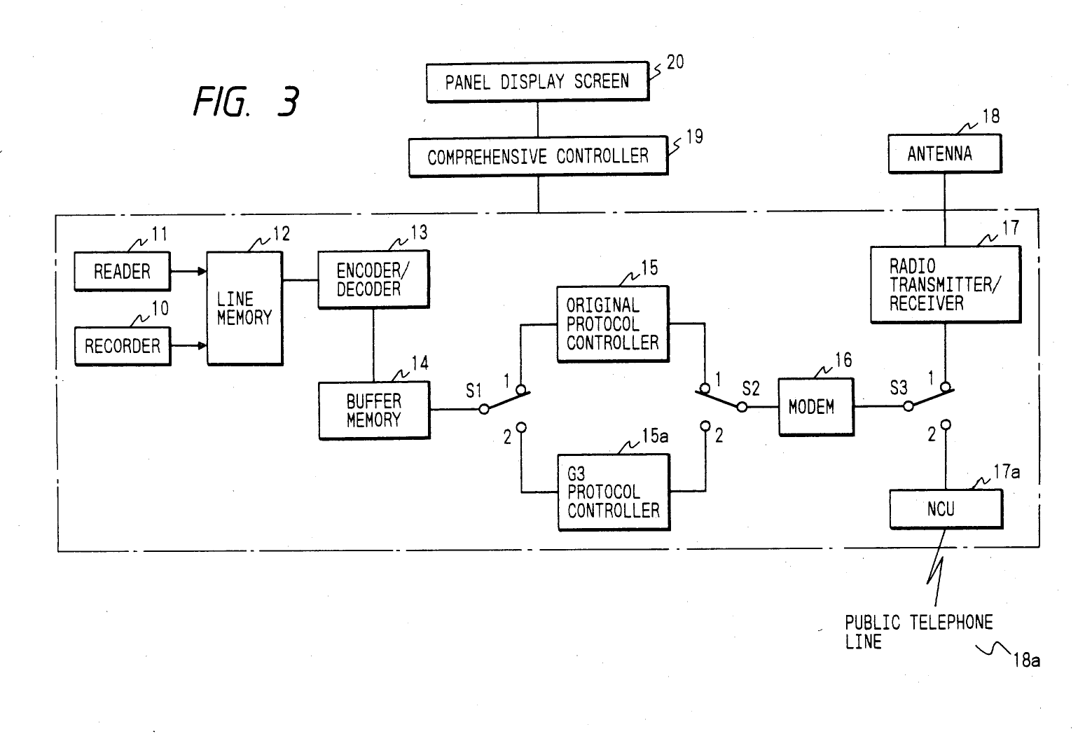

FIG. 3 shows the internal configuration of the radio center facsimile 2. In other words, when communication is made with a radio facsimile terminal of group 1, three switches (S1, S2, and S3) are set to No.1 side to operate the original protocol controller 15. When communication is made with a facsimile terminal connected to a public line, those switches are set to the No. 2 side to operate the general protocol controller 15a. When data is transmitted from the radio facsimile terminal to the general facsimile terminal, the original protocol signals are transmitted first from the radio facsimile terminal to the radio transmitter/receiver 17 of the radio center facsimile 2. Receiving the signals, the comprehensive controller 19 sets the said switches to the No.1 side to pass the signals through the modem 16 and the original protocol controller 15 and saves the signals in the buffer memory. After this, the said switches are set to the No.1 side according to an instruction from the comprehensive controller 19 to read the data from the buffer memory. The protocol is then changed to a general one in the general protocol controller 15a. The data is then passed through the modem 16 and the NUC 17a and sent to the public telephone line 18a and received by the general facsimile terminal of group 3. When data is transmitted from the general facsimile terminal of group 3 to the radio facsimile terminal of group 1 through the public telephone line 18a, it is only needed to reverse the said transmission procedure.

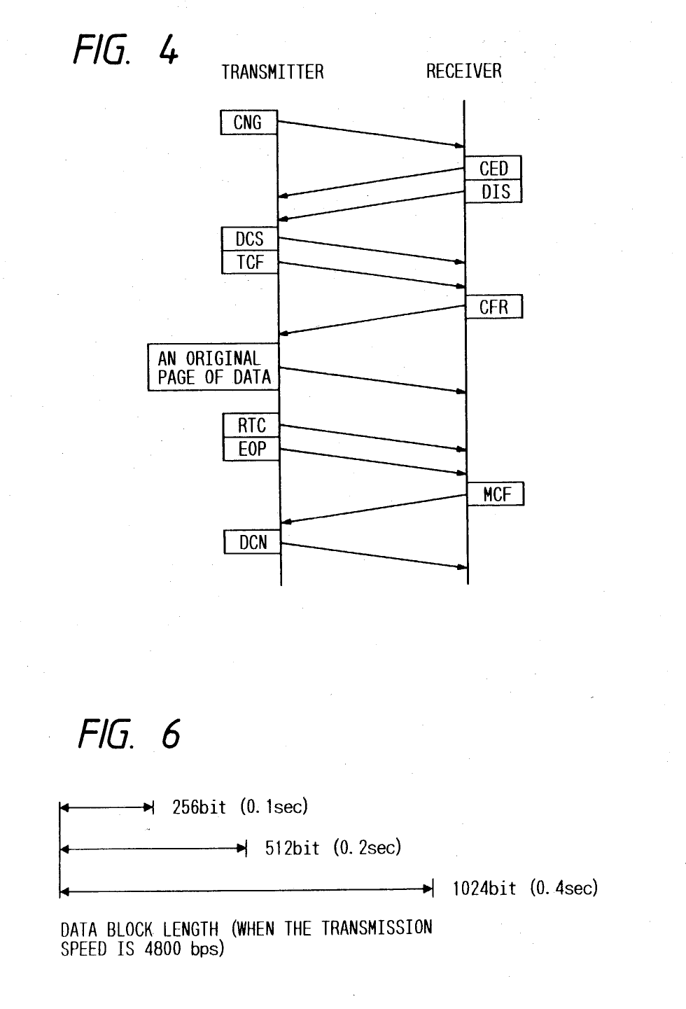

FIG. 4 shows the communication protocol for general facsimile terminals.

At first, when the receiver receives a CNG (calling sound) signal, which results from a series of pre-procedures carried out from the transmitter, it transmits a CED (receiver discrimination signal) and a DIS (digital identification signal). Receiving the CED and DIS signals, the transmitter transmits a DCS (digital command signal) and a TCF (training check signal). After this, the receiver transmits a CFR (Clear For Receiving signal) to the transmitter, and then an original page of data is transmitted. Completing the transmission, the transmitter transmits a RTC (Return To Control signal) and an EOP (End Of Protocol signal). Receiving the EOP signal, the receiver transmits a MCF (Message Confirmation signal) to the transmitter. The transmitter, receiving the MCF, transmits a DCN (disconnection signal) and terminates the communication. In the conventional general protocols, the data length to be transmitted at one time is limited to a page of original data. In the case of radio communications to or from an automobile, they are often interrupted by interferences of other radio waves especially while the subject automobile is running. Since the data length to be transmitted at one time is as long as a page of original data, the communication interruption possibility becomes high and the communication is often disabled.

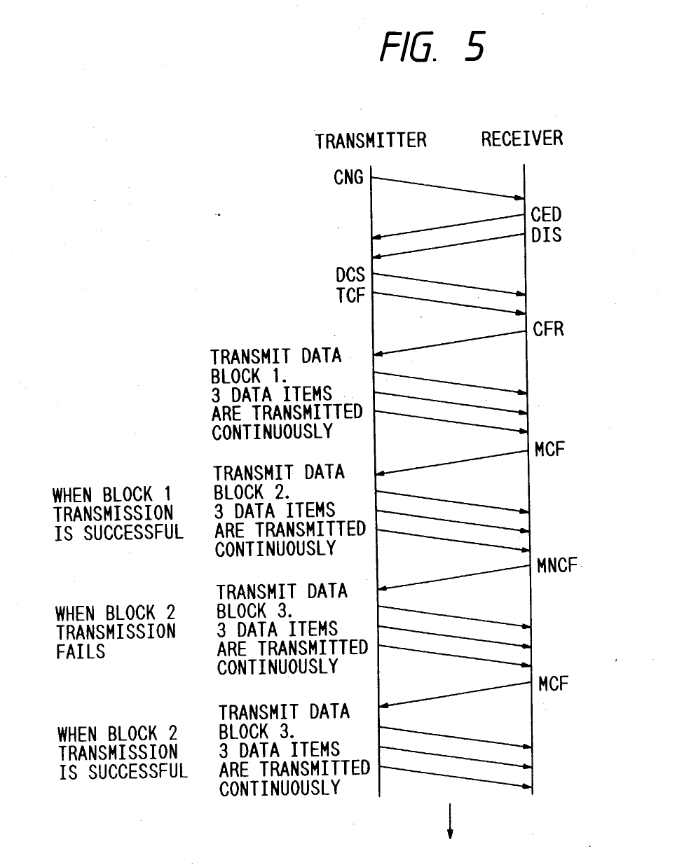

FIG. 5 shows an example of the original communication protocol used in this invention. The steps up to CFR are the same as those shown in FIG. 4. In the step that comes just after the step CFR, a page of transmit data is divided into two or more blocks and each block of data is transmitted three times continuously. Each facsimile terminal and the center facsimile shown in this figure are equipped with a respective error detecting means. When any one of the transmissions carried out three times continuously is successful, the receiver transmits an MCF and the transmitter transmits the next block of data three times continuously. If all of the three transmissions fail, the receiver transmits an MNCF (message not-reached signal) and the transmitter transmits the same data three times again continuously. This error detecting means adopts the following two methods to detect errors; one of the methods judges an error when the transmit data or the data length is shorter or longer than the specified data length. Another method judges that the transmission has been successful if two of the data patterns transmitted three times are identified to be the same, or it judges that the transmission has been unsuccessful when the data patterns transmitted three times are completely the same. Repeating such a series of transmissions, the communication is continued. The number of transmissions, which is three times in this example, is flexible; it can be increased when the radio wave condition is bad and reduced when the condition is good.

FIG. 6 shows examples of the data block length. When the communication speed is 4800 bps, the block length may be 256 bits/about 0.1 see, 512 bits/about 0.2 see, and 1024 bits/0.4 sec. In general, when the radio wave condition is bad, the block length may be set shorter and when the condition is good, it may be set longer. In other words, the block length and the number of transmissions per block can be selected properly according to the radio wave condition in order to assure effective communications. The original communication protocol used in this invention could be more tolerant of radio wave interferences and interruptions and enable communications with general facsimile terminals in the said system configuration.

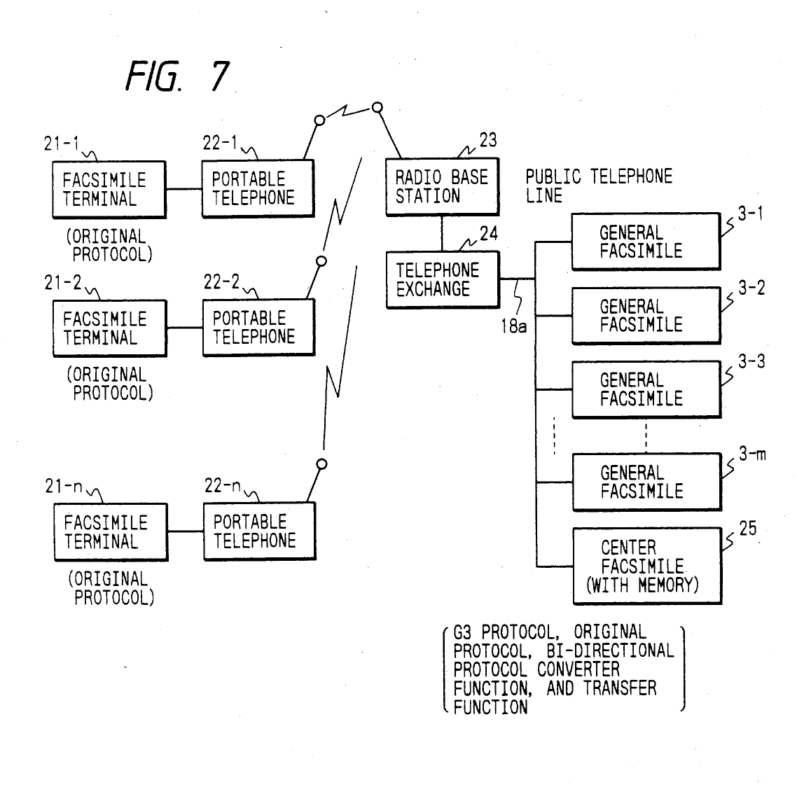

FIG. 7 shows another embodiment of this invention.

In FIG. 7, the radio communication uses existing portable radio telephones 22-1 through 22-n, a base station 23 for radio telephones, a telephone exchange 24, a public telephone line 18a, and general facsimile terminals 3-1 through 3-m. Facsimile terminals 21-1 through 21-n are connected to the portable radio telephones 22-1 22-n, which are mounted on moving objects, while the center facsimile 25, which is equipped with the protocol change function, the original communication protocol, the general communication protocols, and the transfer function, is connected to the general public telephone line. The operation of this system is almost the same as that mentioned in the previous embodiment. The information from the facsimile terminal 21 on the moving object is transmitted together with the remote general facsimile telephone number to the center facsimile 25 through the existing communication systems 22 and 23, as well as through the existing telephone exchange 24. The original communication protocol is used for the communications up to the center facsimile 25, and the center facsimile 25 changes the original protocol to a general one to transfer the information to a remote general facsimile terminal. When information is transmitted from a general facsimile terminal, the information and the telephone number of the connected radio telephone 22 are transmitted to the center facsimile 25. The center facsimile 25 changes the general protocol to the original protocol, then transfers the information to the target radio telephone.

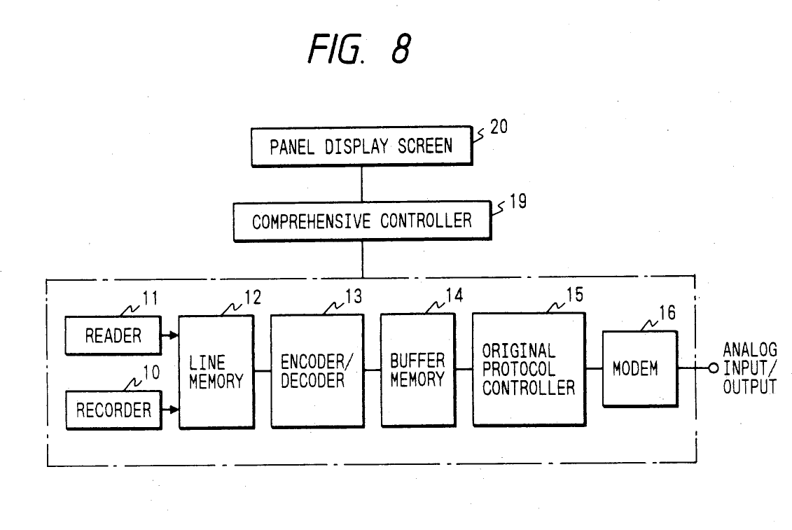

FIG. 8 shows the internal configuration of a facsimile terminal mounted on a moving object, as used in the system of FIG. 7.

The same components as those in FIG. 2 are given the same reference numbers also in FIG. 8. Unlike ordinary facsimile terminals, this facsimile terminal has an original protocol controller 15, and the modem 16 has analog input/output functions.

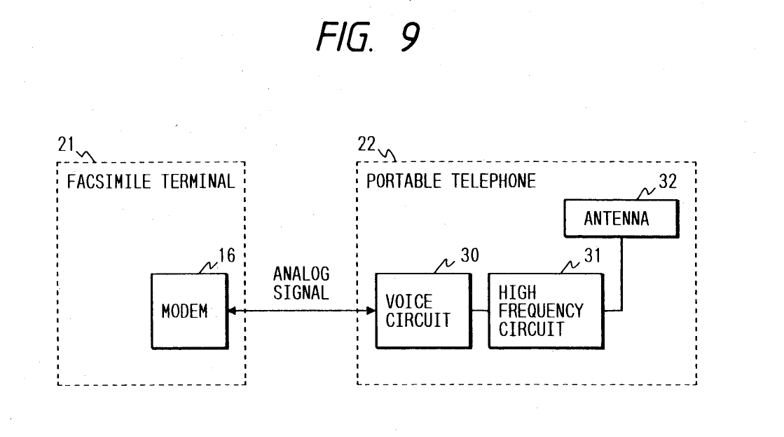

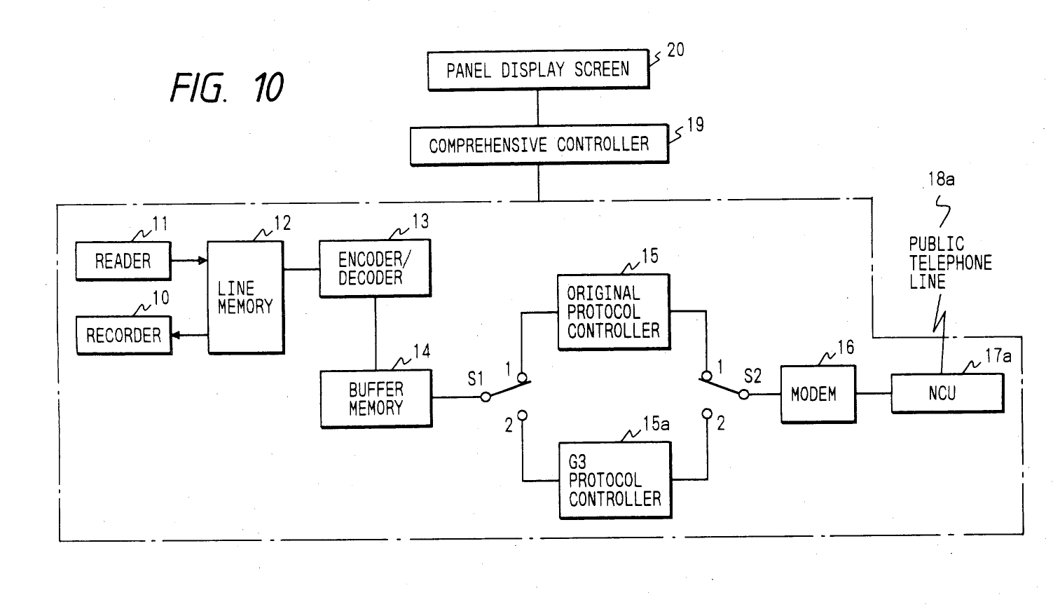

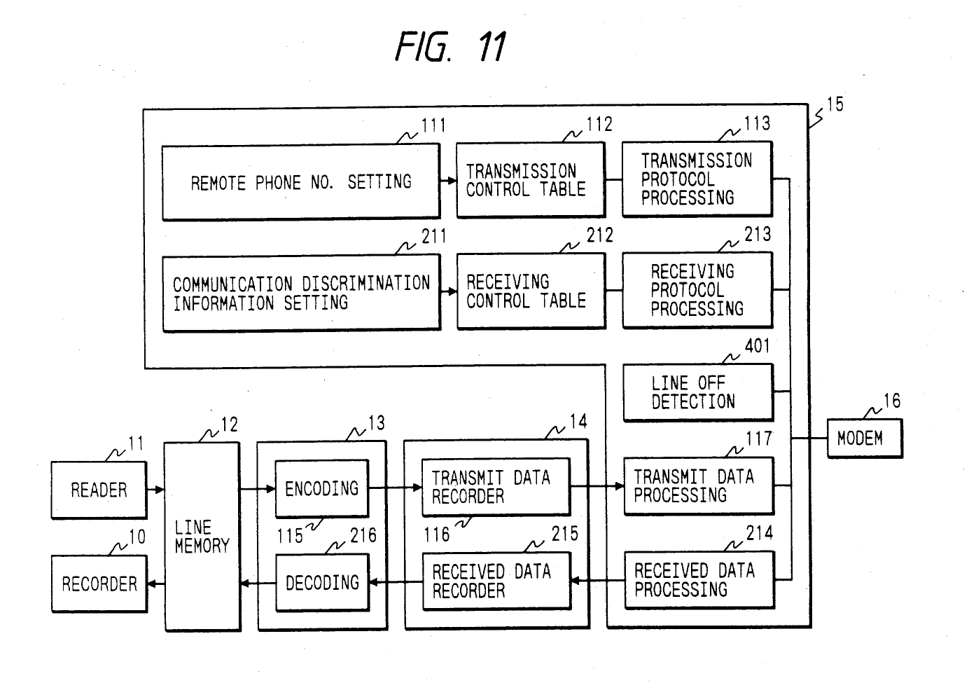

FIG. 9 shows a method of connecting a facsimile terminal to a portable telephone. The analog signals to/from the analog input/output of the modem 16 of the facsimile terminal shown in FIG. 8 are connected to the voice input/output 30 of the portable telephone. The analog signals are then converted to radio signals in the high frequency circuit 31 and transmitted to the radio base station through the antenna 32. Thus, the same operation as that of the radio facsimile terminal shown in FIG. 2 can be assumed. FIG. 10 shows the internal configuration of the center facsimile 25 used in this system. Basically, the configuration is almost the same as that of the radio center facsimile shown in FIG. 3. The only difference is that both the radio transmitter/receiver and the switch 53 are not needed in this configuration since a public telephone line is used for data input/output. Two switches (S1 and S2) are used to select the original protocol/general protocol appropriate to communication with the facsimile terminal mounted on a moving object and the general facsimile terminal. The original protocol used in this case is the same as that shown in FIG. 5. This configuration allows existing radio communication systems to be used, as well as the communications to be made with the facsimile terminals and the center facsimile without the radio communication items. The communication in this case is tolerant of radio wave interruptions.

In the cases mentioned above, the facsimile mounted on a moving object uses only the original protocol. Of course, the system can have general protocols and select one of them which is appropriate to the radio wave condition. When general protocols are prepared together with the original one, the system can also be connected to a public telephone line to communicate with general facsimile terminals.

Next, one more embodiment will be explained for a communication processing to be restarted after an interruption with reference to some figures of the drawing. FIG. 11 shows an example of the system configuration of this invention, that is, an example of a system, such as a facsimile, used to transfer images. It is possible to apply the system to every data communication system. The explanation will be started with the transmission functions of such a system. The remote number setter 111 in the original protocol controller 15 is used to set the target facsimile telephone number. The transmission control table 112 is a memory used to save the information to restart the subject communication after an interruption. The transmission protocol processor 113 is means for exchanging communication control signals with the receiver. The reader 11 is a means for scanning the originals to transmit and generate image signals. For example, a CCD line sensor is used to convert image signals to electric signals. The encoder 115 compresses the amount of the information as image signals entered from the reader 11. For example, MH and MR encoding systems adopted for facsimiles are well known as this encoder. The transmit data memory 116 is used to save encoded image signals. The memory is a semiconductor memory. The transmit data processor 117 transmits data to the receiver. Next, the receiving functions will be explained. The communication discrimination information setter 211 is a means to set communication discrimination information corresponding to a new communication start request from the transmitter. The receiving control table 212 is a memory used to save the information to restart the subject receiving after an interruption. The receiving protocol processor 213 is a means to exchange communication control signals according to the transmission requests. The received data processor 214 is a means to receive data from the transmitter. The received data memory is a means to save received encoded data. The memory is a semiconductor memory. The decoder 216 is a means to decode the received encoded data to original image signals. The recorder 10 is a means to print out image signals on recording paper. For example, a thermal printer may be used as this recorder 10. The line OFF detector 401 has the function to detect line disconnections. The line OFF detecting condition is satisfied, for example, when a signal to indicate the end of communication is received, when the SYNC signal transmitted together with image information cannot be received for more than 5 seconds, or when a data frame cannot be received normally even after it has been transmitted three times continuously. The modem 16 is a means to convert encoded data to analog signals and to transmit/receive those signals through a communication line.

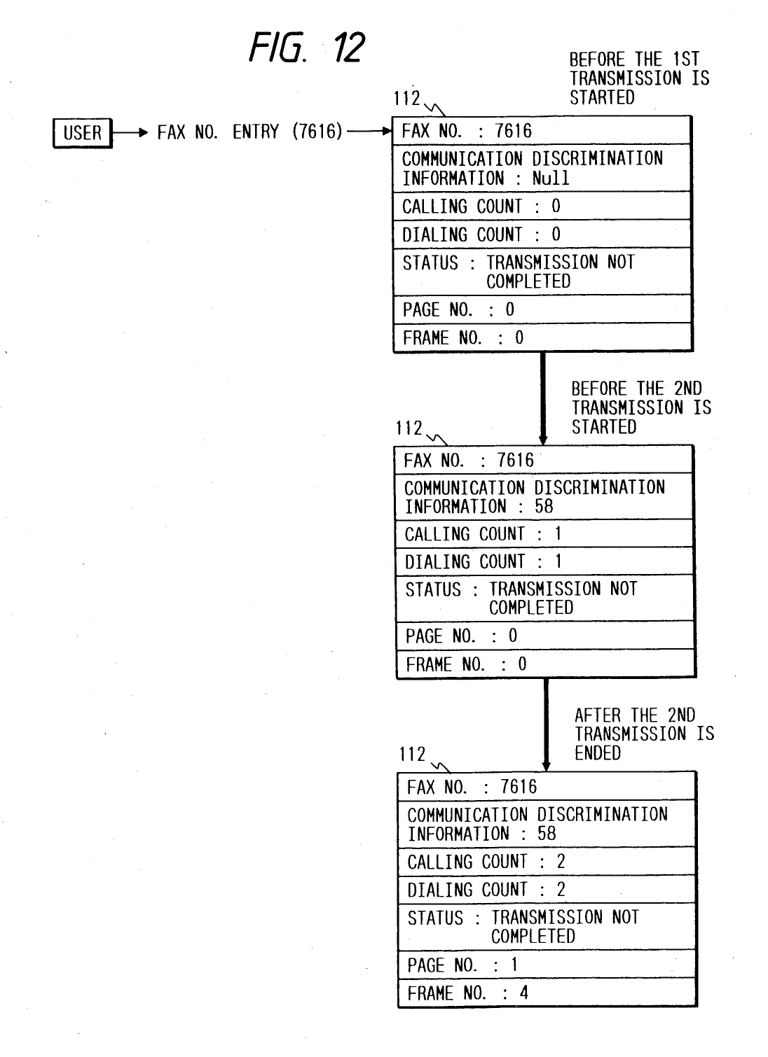

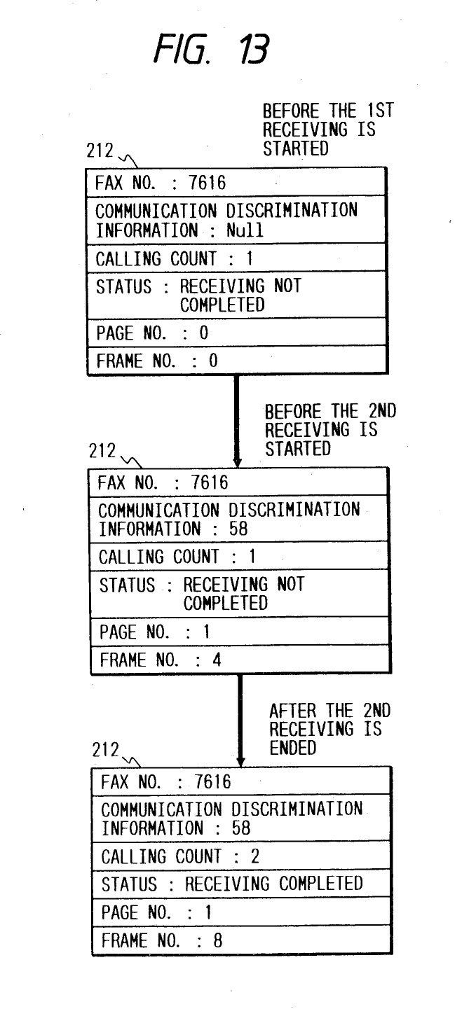

FIG. 12 shows a transmission control table. The encoded data for a sheet of original is divided into 8 frames and transmitted through two operations of transmission. The “FAX number” is a field used to save the remote telephone number entered to the remote number setter 111. If a call is retried after it has been interrupted, the remote telephone is read from this area and the number is dialed automatically. There is no need for the user to dial the number again. The “communication discrimination information” is a field to save the communication discrimination information to be transmitted from the receiver 201 at the first transmission time. The field value is “Null” before the first transmission is started. For the second and subsequent transmissions, the communication peculiar information discriminated from other communications is set in this field. If a communication is restarted after an interruption, the communication discrimination information is transmitted to the receiver from this field. With this information, therefore, the receiver can recognize which communication is to be restarted. The “calling count” is a field used to indicate the number of callings, including the first one issued in response to the communication discrimination information. If this count value exceeds a preset upper limit, re-calling is disabled. The “dialing count” is a field used to indicate the number of dialings made for a call. If this value exceeds the preset upper limit, no more connection request can be issued to the receiver. The “status” is a field used to indicate whether or not the subject encoded data items are all transmitted. The “page number” is a field used to indicate the page number received by the receiver normally through the previous transmission. The “frame number” is a field used to indicate the number of the frame received by the receiver normally through the previous transmission. Both the page number and the frame number are transmitted from the receiver when the subject communication is restarted.

FIG. 13 shows an example of a receiving control table. In this example, the encoded data for a sheet of original data is divided into 8 frames and transmitted in two operations of transmission. The “FAX number” is a field used to save the telephone number of the receiver. The “communication discrimination information” is a field used to save the information, which is set in the communication discrimination information setter 211 when the first receiving is started. Thus, the field data is “Null” before the first receiving operation is started. For the second and subsequent communications, the information to discriminate the subject communication from others is saved in this field. If receiving is retried after an interruption, this field value is compared with the communication discrimination information transmitted from the transmitter. With this information, therefore, the receiver can judge which calling should be received. The “called count” is a field used to indicate the number of operations to receive calls including the first one in response to the same communication discrimination information. If this value exceeds a preset upper limit, receiving the calls in response to the same communication discrimination information is disabled. The “status” is a field used to indicate whether or not the subject encoded data items are all received. The “page number” is a field used to indicate the number of the page received by the receiver normally through the previous receiving operation. The “frame number” is a field used to indicate the number of the page received by the receiver normally through the previous receiving operation. The “frame number” is a field used to indicate the number of the frame received by the receiver normally through the previous receiving operation. Both the page number and the frame number are transmitted to the transmitter when the subject communication is restarted.

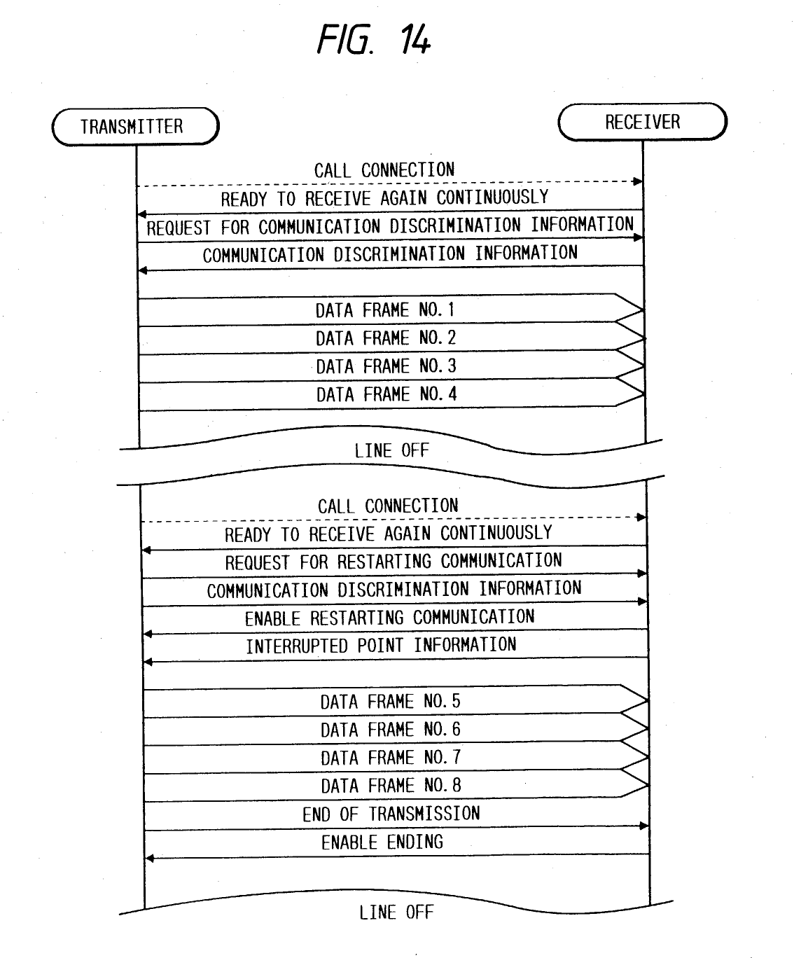

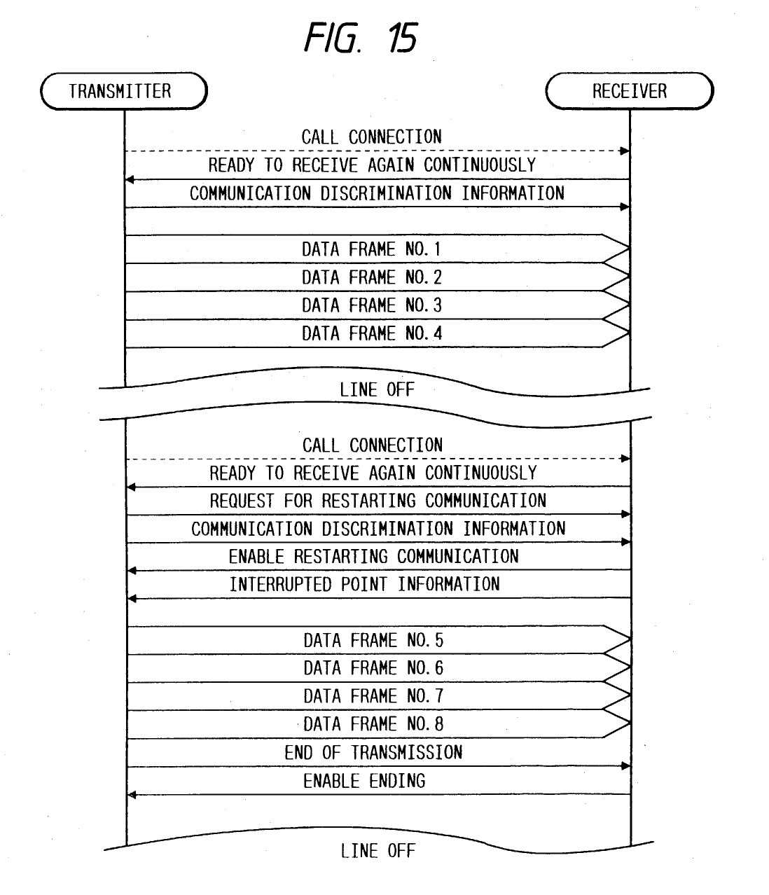

FIG. 14 shows an example of the communication procedure in this invention. In this example, the communication discrimination information is set by the receiver. The encoded data for a sheet of original, which is divided into 8 frames, is transmitted from the transmitter to the receiver as follows: The user sets the remote telephone number in the remote number setter 111. Then transmitter calls up the receiver. When the receiver receives the call and the line is connected, the receiver notifies the transmitter of its capability to receive data continuously after each interruption (receiving data with the original protocol of this invention that enables the communication to be restarted after each interruption). Since it is the first communication, the transmitter transmits a request for the communication discrimination information to the receiver. In response to this, the receiver sets the information to discriminate the subject communication from others and transmits the information to the transmitter. The communication discrimination information may be, for example, one of the serial numbers that is incremented one by one each time a new communication is received by the receiver. The transmitter transmits data in frames, each of which comprises 256 bytes and is given a serial number. If the SYNC signal to be transmitted together with image information cannot be detected for more than 5 seconds or when data cannot be received normally after it is transmitted three times continuously, then the line is disconnected and the communication is stopped. Detecting the line OFF, the transmitter calls up the receiver again to connect the line. In this case, the user is not requested to dial the remote number again. The calling is made automatically according to the FAX number saved in the transmission control table 112. Then, the receiver notifies the transmitter of its capability to restart the communication after each interruption. The transmitter transmits a request for restarting, as well as the target communication discrimination information. This communication discrimination information is the one saved in the communication discrimination information field of the transmission control table 112 when the first communication is started. Receiving this communication discrimination information, the receiver, for example, when two or more communications are interrupted at that time, can recognize which communication is to be restarted. After this, the receiver transmits the ready to restart signal, as well as the number of the final page (1 in this case) and the number of the final frame (4 in this case) that has not been received normally through the first communication as interruption point information. In response to this, the transmitter starts transmission of the 5th and later frames read from the transmit data memory 116 according to the page number and the frame number received as the interruption point information. If the image data up to the interruption point in the communication discrimination information transmitted together with the restart request is not saved in the received data memory 216, then the receiver notifies the transmitter that restarting is impossible. When such information is received, the transmitter requests the receiver to send new communication discrimination information and restarts transmission at the beginning of the first page as a new communication. When the transmission of all the subject data items is finished normally, the transmitter transmits the end of transmission signal. When all the data items are received normally, the receiver notifies the transmitter of having received a complete communication. Receiving this signal, the transmitter disconnects the line.

FIG. 15 shows an example of the communication in this invention. In this example, the transmitter sets the communication discrimination information. When the user sets the remote dialing number (telephone number) in the remote number setter 111 and the receiver receives a call from the transmitter and the line is connected, the receiver notifies the transmitter of its capability to restart receiving after each interruption. The transmitter sets the information to discriminate the subject communication from others and transmits the information to the receiver, since it is the first transmission. The subsequent processings are the same as those shown in FIG. 14.

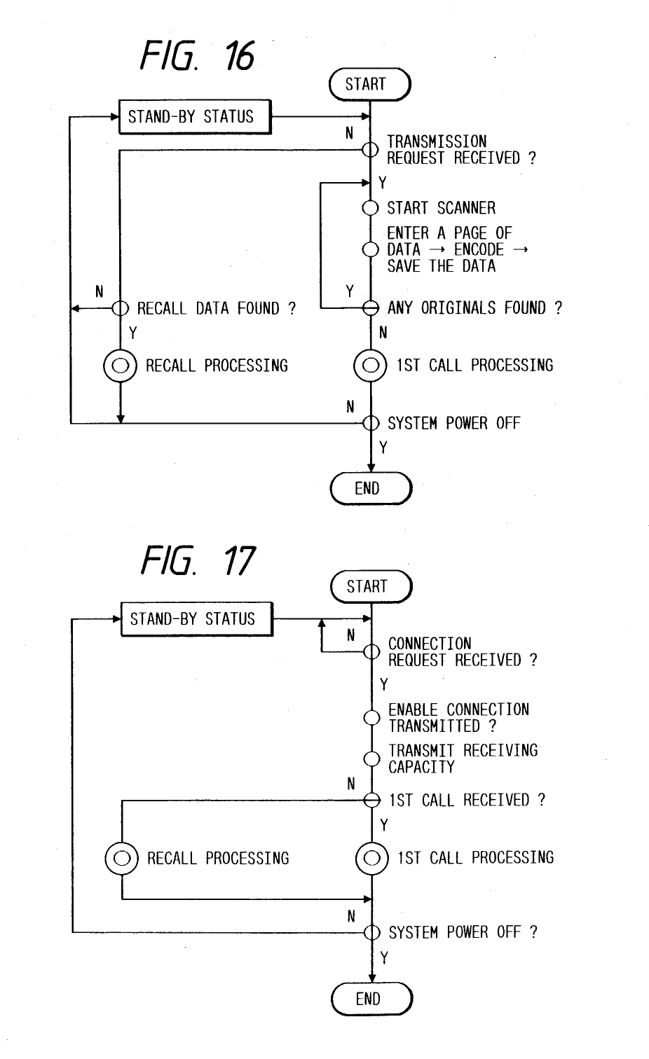

FIG. 16 shows an example of calling from the receiver. When the user sets a sheet of original data to transmit and enter the remote dialing number, the system judges that a transmission request is issued, and thus actuates the reader 11 to read the original data. The read data is encoded in the encoder 115 and saved in the transmit data memory 116. When there are two or more sheets of original data, the said processings are repeated.

Then, the first call processing is executed. On the other hand, if there is no transmission request issued, but there is any data for which transmission is to be restarted because the communication has been stopped due to line disconnection, then re-calling is tried. In other cases, the system stands by until the system power supply is turned OFF.

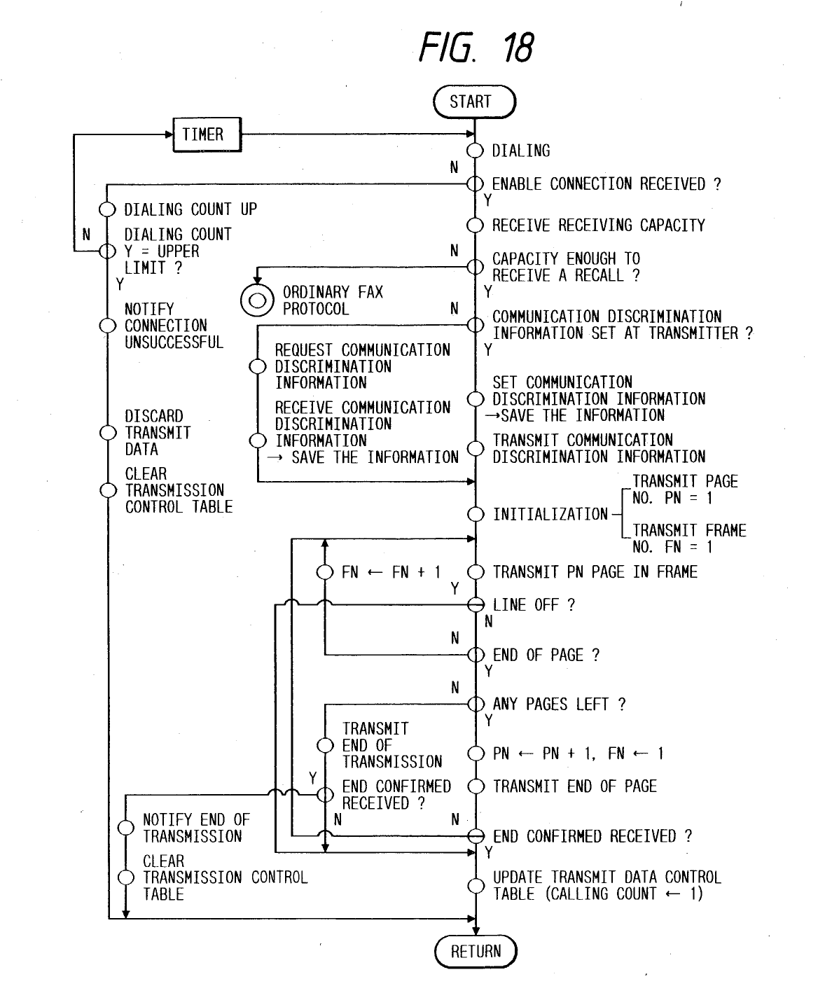

FIG. 18 shows an example of the first call processing. The dialing number saved in the FAX number field of the transmission control table 112 is dialed automatically to connect to the remote facsimile terminal. Then, the transmitter receives the information indicating whether or not the receiver has a function to restart the subject transmission after each interruption. If the receiver does not have the function, a general facsimile communication protocol, such as G3, is used for the communication (the details of the protocol are omitted here). When the receiver has the function, either the transmitter or the receiver sets the communication discrimination information and sends it to the other. If the transmitter sets the communication discrimination information, the transmitter saves the information in the communication discrimination information memory in the transmission control table 112 and transmits the information to the receiver. If the receiver sets the communication discrimination information, the transmitter requests the receiver to send the communication discrimination information, and the transmitter receives and saves the information in the communication discrimination information memory in the transmission control table 112. After this, the transmitter initializes both the transmit page number and the transmit frame number, and starts the transmission of the coded data at the first frame in the first page. If the line is disconnected during this image data communication, the transmitter updates the transmission control table 112 and terminates the processing. The transmission control table 112 is updated, as shown in FIG. 12, so that the communication discrimination information may be updated from Null, which is set before the transmission is started, to 58, and the calling count may be updated from 0 to 1, respectively. This transmission control table 112 is also updated when the end confirmation signal cannot be received after the End of Page signal is transmitted, indicating that a page of data has been transmitted. If the line cannot be connected even when the dialing number is dialed, then the number is dialed at intervals preset for the timer. If the dialing count reaches the preset upper limit, “connection unsuccessful” is sent to the user. In this case, the transmit data in the transmit data memory 116 is discarded and the transmission control table is cleared.

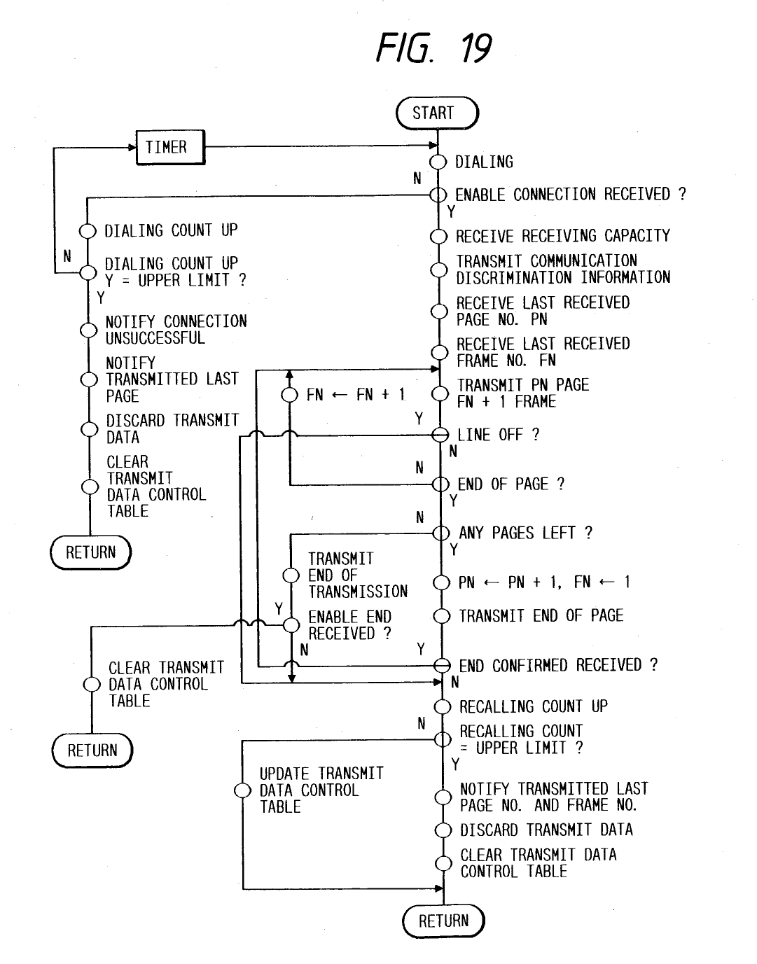

FIG. 19 shows an example of re-call processings. The dialing number saved in the FAX number field of the transmission control table 112 is dialed automatically. When the line is connected to the receiver, the transmitter confirms that the receiver can restart the subject communication after each interruption according to the information received from the receiver. Then, the transmitter transmits the communication discrimination information to the receiver. The information is saved in the communication discrimination information memory in the transmission control table 112. The transmitter then receives the last page number PN and the frame number FN of the coded data received from the receiver in the first call processing. The transmitter then restarts the transmission of the coded data at the FN+1 frame in the PN page. If the line is disconnected during this transmission, the transmitter updates the transmission control table 112 and terminates the processing. The transmission control table is updated at this time, as shown in FIG. 12, so that the calling count may be updated from 1, which is set before the second transmission is started, to 2. The transmission control table is also updated when the page end confirmation signal cannot be received after the End of Page signal is transmitted, indicating that a page of data has been transmitted. Re-calling is tried for a line re-connection except when the communication is ended normally. However, when the recalling count reaches the preset upper limit, the last page number and the last frame number set in the transmission control table are sent to the user and the transmit data in the transmit data memory 116 is discarded. Then, the transmission control table 112 is cleared. If a line cannot be connected when the number is dialed, a re-connection is tried at intervals preset for the timer. When the dialing count reaches the preset upper limit, the connection unsuccessful condition is indicated to the user, the transmit data in the transmit data memory 116 is discarded, and the transmission control table 112 is cleared.

FIG. 17 shows an example of the processings carried out by the receiver. Receiving a request for connection from the transmitter, the receiver transmits the Connection Enable signal and notifies the transmitter of its capability to restart the subject transmission after each interruption. Receiving the first call, the receiver begins the processing for the first call received. When it is not receiving the first call, the receiver begins the processing for a re-call received. In other cases, the receiver stands by until the system power supply is turned OFF.

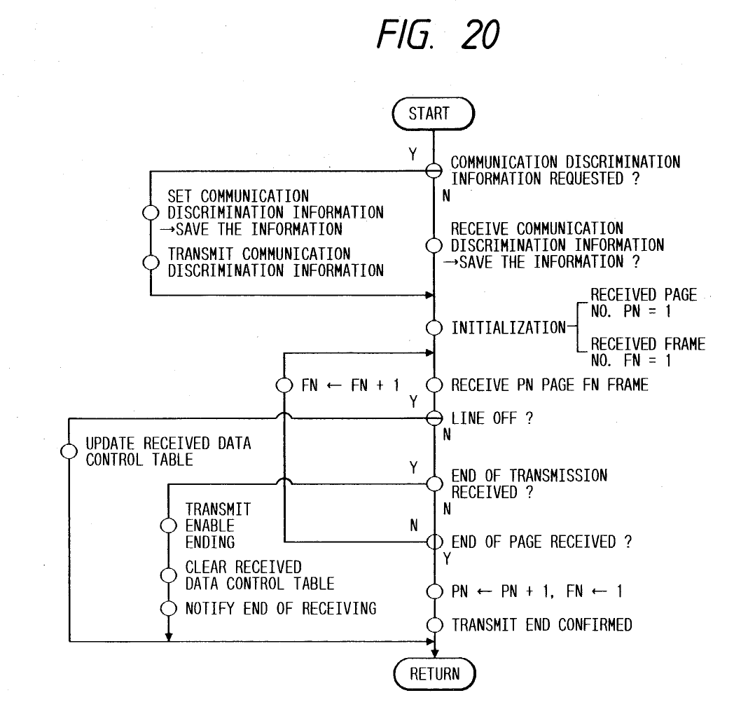

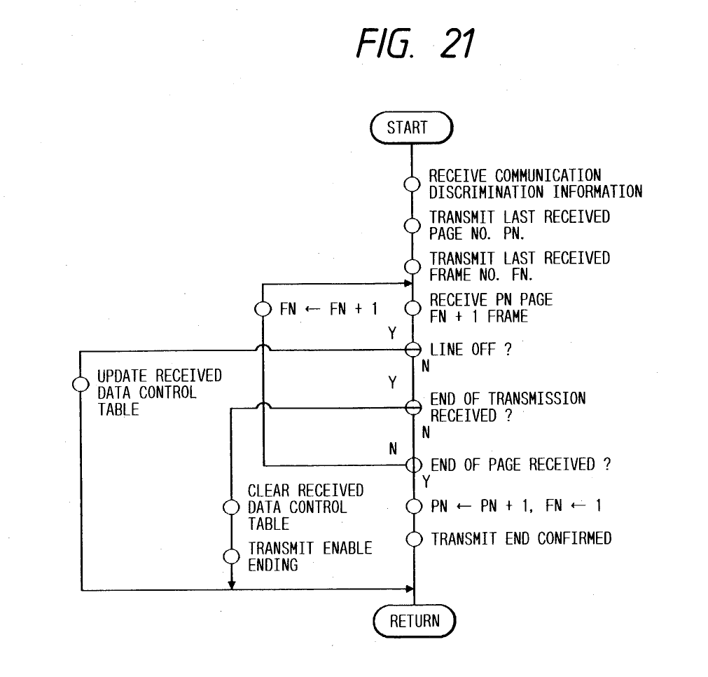

FIG. 20 shows an example of the processing for the first call received. When the transmitter asks for the communication discrimination information, the receiver sets the communication discrimination information and saves the information in the communication discrimination information memory in the receiving control table 212. Then, the receiver transmits the information to the transmitter. When the receiver receives the communication discrimination information from the transmitter, the receiver saves the information in the communication discrimination information memory in the receiving control table 212. Then, the receiver initializes both the received page number and the received frame number and begins receiving the coded data at the first frame in the first page. If the line is disconnected during the communication, the receiving control table 212 is cleared and the processing is ended. The receiving control table 212 is updated, as shown in FIG. 13, so that the communication discrimination information may be updated from Null, which is set before the first receiving is started, to 58, and the received calling count may be updated from O to 1, respectively. When receiving End of Transmission, the receiver transmits Ready to End to the transmitter and notifies the user of End of Receiving, then clears the receiving control table 212. After this, the data in the received data memory 116 is restored to image data in the decoder 216 and is output from the recorder 10. When receiving End of Page, the receiver counts up the last received page number to PN+1 and clears the last frame number, then transmits the end confirmation signal to the transmitter.

FIG. 21 shows an example of the processing for a re-call received. Receiving the communication discrimination information from the transmitter, the receiver transmits the last page number PN and the last frame number FN of the data received normally in the processings so far. Then, the receiver begins receiving coded data at the FN+1 frame in the PN page. If the line is disconnected during the communication, the receiver updates the receiving control table 212 and terminates the processing. The receiving control table is updated as shown in FIG. 13 so that the received calls count may be updated from 1, which is set before the second receiving is started, to 2. When receiving End of Transmission, the receiver transmits Ready to End to the transmitter and notifies the user of End of Receiving, then clears the received data control table 212. The data in the received data memory 215 is restored to image data in the decoder 216 and output from the recorder 10. When receiving End of Page, the receiver counts up the last received page number PN to PN+1, and clears the last frame number FN, then transmits the end confirmation signal to the transmitter.

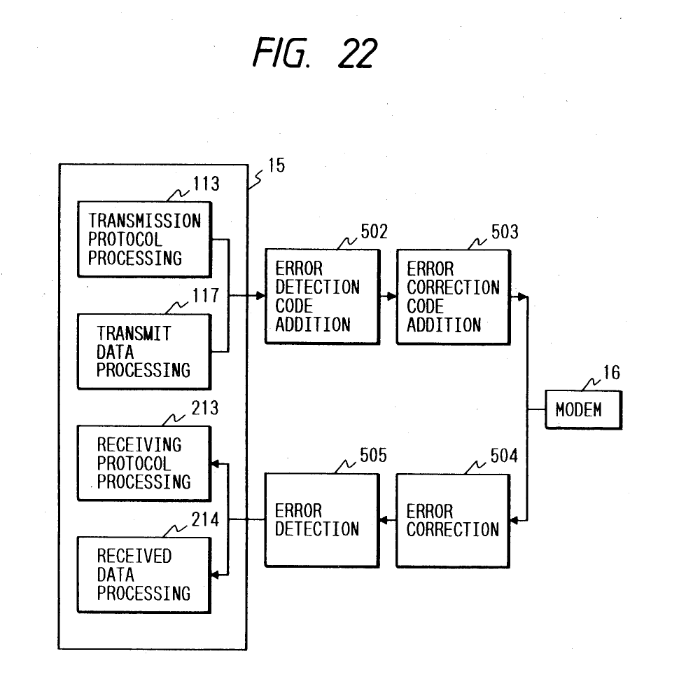

FIG. 22 shows an embodiment of this invention. The original protocol controller 15 executes the original communication protocol of this invention. The error detection code adder 502 is a means to add an error detection code in units of multiple bits both to the image data transmitted from the transmit data processor 117 and the protocol signals transmitted from the transmission protocol processor 113. For example, a 2-byte error detection code is added to each data block in units of 256 bytes just like the HDLC protocol. This 2-byte error code allows the receiver to detect whether or not an error exists in each data block of 256 bytes. The error correction code adder 503 is a means to add a code for correcting an error in units of multiple bits. This error correction code allows the receiver to correct errors on the receiver side in units of multiple bits. For example, an 8-bit code is added to each data word of 7 bits just like the BCH error correction code. The error corrector 504 is means for correcting received data errors using the code added in the error correction code adder 503. For example, if an 8-bit code is added for each data word of 7 bits, then up to the 2-bit errors in the 7 bits can be corrected on the receiver side. Bit errors that occur at random can be corrected using this means. The error detector 505 requests the transmitter to re-transmit data strings when an error is detected, for example, in a 256-byte data string according to the error detection code added in the error detection code adder 502. If no error is detected, the error detector 505 passes the data, if it is image data, to the data processor 214. If it is protocol data (signals), the error detector 505 passes the signals to the received protocol processor 213. Thus, the said configuration can cope with communication interruptions, data random errors, and burst errors.

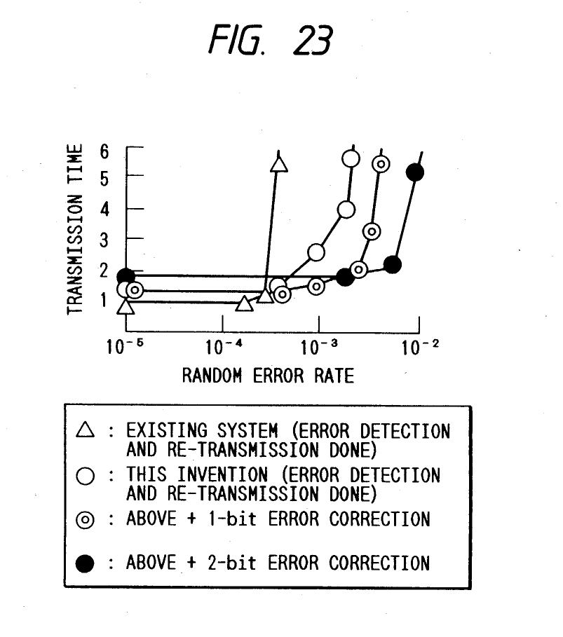

FIG. 23 shows the relative values of each communication system transmission time in relation to the random error rate. In case of the existing facsimile system equipped with the function to restart data transmission after it is interrupted with detection of an error, the communication is disabled at an error rate of 1/5000. On the contrary, in the case of the communication system that can restart the subject transmission after each interruption caused by a detected error, the communication is continued up to an error rate of 1/700. In addition, if the BCH single-bit error correction function that is realized by adding a 3-bit code to each data of 4 bits, then the communication can be assured up to an error rate of 1/500. If the BCH 2-bit error correction function that is realized by adding an 8-bit code to each data of 7 bits is added to the system, the communication can be assured up to an error rate of 1/200.

According to this invention, the communication is enabled between the communication terminal that has the said original protocol and the communication terminal connected to a general public telephone line. Even when the communication is interrupted, the user is not requested to set the remote telephone number again for re-connecting the line. When two or more communications have occurred at the remote terminal, the communication discrimination information is sent to the remote terminal before restarting the subject communication. Thus, the communication can be restarted precisely at the interruption point. In addition, the numbers of the frames successfully transmitted before the communication is interrupted are recognized and the communication is restarted at the data frame immediately following the last transmitted frame, so that it is not necessary to repeat the same communication from the first data frame.

What is claimed is:

1. A communication system comprising:
a plurality of portable or mobile facsimile terminals;
a plurality of general facsimile terminals connected to a public telephone line; and
a communication controller for relaying information between said two types of facsimile terminals,
wherein said communication controller comprises:
means for changing communication protocols for received information between an original communication protocol dedicated for communicating with said portable or mobile facsimile terminals and a plurality of general communication protocols for communicating with said general facsimile terminals connected to said public telephone line,
wherein said communication controller relays communication discrimination information from a receiving facsimile terminal to a transmitting facsimile terminal,
wherein said communication discrimination information is sent by the receiving facsimile terminal at the start of a communication in response to a request for communication discrimination information from the transmitting facsimile terminal, and
wherein said communication discrimination information indicates the number of times the communication has been restarted to complete a current facsimile transmission and indicates the amount of data of the current facsimile transmission that has been transmitted.

2. A communication system according to claim 1, wherein said communication controller further comprises:
means for receiving information using said dedicated original communication protocol from a portable or mobile facsimile terminal and means for transmitting data to a specified general facsimile terminal through a public telephone line after the dedicated original protocol has been changed to a general communication protocol by said communication protocol change means.

3. A communication system according to claim 1, wherein said communication controller further comprises:
means for receiving information from a general facsimile terminal connected to a public telephone line; and
means for transmitting the information to a specified portable or mobile facsimile terminal after the general communication protocol has been changed to said dedicated communication protocol.

4. A communication system according to claim 1, wherein each portable or mobile facsimile terminal and said communication controller are equipped with a respective radio communication means.

5. A communication system according to claim 1, wherein said communication controller comprises:
means for saving information and for transmitting said information a plurality of times in accordance with the status of communication with said portable or mobile facsimile terminal.

6. A communication controller having a function that allows the same communication protocol to be used for communications between a plurality of portable facsimile terminals and terminals other than portable facsimile terminals, said communication controller comprising:
means for changing from a dedicated communication protocol dedicated for communicating with said portable facsimile terminals to a general communication protocol for communicating with said terminals other than said portable facsimile terminals;
means for receiving information from a portable facsimile terminal and for transferring said information to a terminal other than a portable facsimile terminal, connected to a specified public telephone circuit using a general communication protocol; and
means for transmitting information received from said terminal other than a portable facsimile terminal, connected to said public telephone circuit after the communication protocol has been changed from said general communication protocol to said dedicated communication protocol,
wherein said communication controller relays communication discrimination information from a receiving terminal other than a portable facsimile terminal to a transmitting portable facsimile terminal,
wherein said communication discrimination information is sent by the receiving terminal other than a portable facsimile terminal at the start of a communication in response to a request for communication discrimination information from the transmitting portable facsimile terminal, and
wherein said communication discrimination information indicates the number of times the communication has been restarted to complete a current facsimile transmission and indicates the amount of data of the current facsimile transmission that has been transmitted.

7. A communication controller according to claim 6, wherein said communication controller only changes protocols between said dedicated communication protocol and said general communication protocol and transfers data using these communication protocols.

8. A communication controller according to claim 6, wherein both said portable facsimile terminals and said communication controller have respective radio communication means.

9. A communication controller according to claim 6, wherein said communication controller has means for saving information and for transmitting said information repetitively in accordance with the status of communication with said portable facsimile terminal.

10. A portable or mobile facsimile terminal comprising:
means for effecting radio communications with a communication controller using a dedicated communication protocol which allows for communication with portable or mobile facsimile terminals;
means for storing information; and
means for transmitting said information to said communication controller a number of times determined by the status of communication with said communication controller;
wherein said communication controller comprises:
means for transmitting/receiving information using not only said dedicated communication protocol, but also general communication protocols which allow for communication with facsimile terminals other than said portable or mobile facsimile terminals, and
means for changing between said dedicated and general communication protocols depending on the communication to be conducted,
wherein said communication controller relays communication discrimination information from a receiving facsimile terminal to a transmitting facsimile terminal,
wherein said communication discrimination information is sent by the receiving facsimile terminal at the start of a communication in response to a request for communication discrimination information from the transmitting facsimile terminal, and
wherein said communication discrimination information indicates the number of times the communication has been restarted to complete a current facsimile transmission and indicates the amount of data of the current facsimile transmission that has been transmitted.

11. A communication system comprising:
a base station;
a plurality of radio telephones for communicating with said base station;
a facsimile terminal connected to one of said radio telephones and operated with a dedicated communication protocol which allows for communication with said facsimile terminal connected to said one radio telephone;
a plurality of facsimile terminals connected to said base station via a public telephone line and a telephone exchange and
a communication controller connected to said public telephone line and having means for changing between said dedicated communication protocol and general communication protocols which allow for communication with said facsimile terminals connected to said base station via said public telephone line and said telephone exchange,
wherein said communication controller relays communication discrimination information from a receiving facsimile terminal to a transmitting facsimile terminal,
wherein said communication discrimination information is sent by the receiving facsimile terminal at the start of a communication in response to a request for communication discrimination information from the transmitting facsimile terminal, and
wherein said communication discrimination information indicates the number of times the communication has been restarted to complete a current facsimile transmission and indicates the amount of data of the current facsimile transmission that has been transmitted.

12. A communication system for transmitting and receiving information between a portable or a mobile facsimile terminal and a general facsimile terminal, said communication system comprising:
a communication controller, including a function of changing protocols, which sends calls on communication lines to transmit information to a terminal, and receives calls from terminals on said communication lines to receive information from said terminals,
wherein said communication controller comprises:
means for changing communication protocols for received information between a specified communication protocol dedicated for communicating with the portable or mobile facsimile terminal and a general facsimile communication protocol for communicating with the general facsimile terminal which is connected to communication lines,
wherein said communication controller comprises:
means for exchanging communication discrimination information with terminals each time a new communication for transferring information is started, and means for restarting a communication by exchanging said communication discrimination information and interruption point information after said communication has been interrupted and before it is restarted,
wherein said communication controller relays communication discrimination information from a receiving facsimile terminal to a transmitting facsimile terminal,
wherein said communication discrimination information is sent by the receiving facsimile terminal at the start of a communication in response to a request for communication discrimination information from the transmitting facsimile terminals, and
wherein said communication discrimination information indicates the number of times the communication has been restarted to complete a current facsimile transmission and indicates the amount of data of the current facsimile transmission that has been transmitted.

13. A communication system according to claim 12, wherein said means for exchanging communication discrimination information allows either of a transmitter terminal or a receiver terminal to send the communication discrimination information and notifies the other of said transmitter and receiver terminals of the sent information.

14. A communication system according to claim 12, wherein said means for exchanging communication discrimination information and interruption point information allows a transmitter terminal to notify a receiver terminal of the communication discrimination information and the receiver terminal to notify the transmitter terminal of an interruption point in a communication.

15. A communication system according to claim 12, wherein the communication of information between a transmitter terminal and a receiver terminal includes at least one of an auto error correction function and an auto error detection and re-transmission function.

16. A communication system according to claim 12, wherein said communication controller transmits information to the portable or mobile facsimile terminal using a specified communication protocol, and after receiving said information from said general facsimile terminal exchanging said communication discrimination information.

17. A communication system according to claim 12, wherein said communication controller transmits information to the general facsimile terminal using a general facsimile communication protocol, and after receiving said information from the portable or mobile facsimile terminal exchanging said communication discrimination information.
